(19) United States
(12) Patent Application Publication
(10) Pub. No.: US 2016/0094301 A1
(43) Pub. Date: Mar. 31, 2016

(54) AUDIO SIGNAL PROCESSING DEVICE

(71) Applicant: YAMAHA CORPORATION, Hamamatsu-shi (JP)

(72) Inventors: Kotaro TERADA, Hamamatsu-shi (JP); Shunichi KAMIYA, Hamamatsu-shi (JP)

(21) Appl. No.: 14/862,447

(22) Filed: Sep. 23, 2015

(30) Foreign Application Priority Data
Sep. 25, 2014 (JP) 2014-194566

(51) Int. Cl. H04H 60/04

(52) U.S. Cl. CPC H04H 60/04

(57) ABSTRACT

In an audio signal processing device having an input port for inputting an audio signal from an outside and a signal processing channel for processing an audio signal inputted from the input port, a device connected to the input port is identified, and a value of a parameter stored as a preset in a predetermined memory in correlation with the identified device is set as a value of a parameter used in signal processing in a signal processing parts provided in the input port.

### TECHNICAL FIELD

The invention relates to an audio signal processing device having a signal processing channel processing an audio signal inputted from an input port.

### BACKGROUND ART

It has been conventionally known an audio signal processing device, such as a digital mixer, having an input port inputting an audio signal from the outside and a signal processing channel processing an audio signal inputted from the input port.

Such an audio signal processing device is described in NPL1 for example.

### CITATION LIST

### Non Patent Literature

{NPL1} “DIGITAL MIXING CONSOLE CL5 CL3 CL1 USER'S MANUAL” Yamaha Corporation, 2012

### SUMMARY OF INVENTION

### Technical Problem

Incidentally, it is often performed in a digital mixer that a device to be a supply source of an audio signal, such as a microphone, is connected to an input port to input an audio signal, and the audio signal inputted from the input port is supplied to and processed in one or more input channels connected to the input port by an input patch.

In this case, in a conventional digital mixer, all characteristic adjustments of audio signal to be inputted are substantially performed in the input channels. Then, the user sets parameters of a signal processing part provided in the input channel at appropriate values, so as to obtain an audio signal with desired characteristics in which frequency characteristic, level, and so on of the inputted audio signal are adjusted according to the genre, use, or the like of the music.

Accordingly, there has been a problem that even when the parameters of the signal processing part provided in the input channel are set once so that an audio signal with desired characteristics can be obtained, if the device used for inputting the audio signal is changed thereafter, the parameters have to be set over again by adding characteristics of the device after being changed, which is troublesome work.

Such a problem can similarly occur in an audio signal processing device other than a digital mixer.

It is an object of the invention to solve such problems and to reduce the troublesome work of changing setting when a device connected to an input port is changed in an audio signal processing device having signal processing channels processing an audio signal inputted from the input port.

### Solution to Problem

To attain the above object, an audio signal processing device of the invention is an audio signal processing device having an input port for inputting an audio signal from an outside and a signal processing channel for processing an audio signal inputted from the input port, the audio signal processing device including: an identifying device configured to identify a device connected to the input port; and a parameter setting device configured to set a value of a parameter, which is stored in a predetermined memory in correlation with the device identified by the identifying device, as a value of a parameter used in signal processing in a signal processing parts provided in the input port.

In the above parameter control device, it is conceivable that an accepting device configured to accept input of a circuit table indicating a correlation between the input port and a device connected to the input port is further included, the identifying device identifies the device to be connected to the input port based on the circuit table accepted by the accepting device, and wherein the parameter setting device executes the setting automatically when the accepting device accepts input of the circuit table.

The above configuration can be realized or embodied as an arbitrary style such as a system, a method, a computer program, a storage medium storing a computer program, other than the above device.

### Advantageous Effects of Invention

The configuration as described above can reduce the troublesome work of changing setting when a device connected to an input port is changed in an audio signal processing device having signal processing channels processing an audio signal inputted from the input port.

### BRIEF DESCRIPTION OF DRAWINGS

FIG. 1 is a diagram illustrating a hardware configuration of a digital mixer as an embodiment of an audio signal processing device of the invention.

FIG. 2 is a diagram illustrating a functional configuration of input and output of an audio signal in a waveform I/O and signal processing executed in a DSP of the digital mixer illustrated in FIG. 1.

FIG. 3 is a diagram illustrating a more detailed structure of an input port and an input channel.

FIG. 4 is a diagram illustrating an example of a preset table stored in the digital mixer.

FIG. 5 is a diagram illustrating an example of a preset setting screen.

FIG. 6 is a flowchart of a process executed by a CPU of the digital mixer illustrated in FIG. 1 when an OK button is pressed down in the preset setting screen.

FIG. 7 is a diagram illustrating a data example of a circuit table.

FIG. 8 is a flowchart of a process executed by the CPU of the digital mixer illustrated in FIG. 1 when data of the stored circuit table are updated.

FIG. 9 is a diagram illustrating an example of a screen for specifying a device connected to an input port.

### DESCRIPTION OF EMBODIMENTS

Hereinafter, an embodiment for carrying out the invention will be described specifically based on drawings.

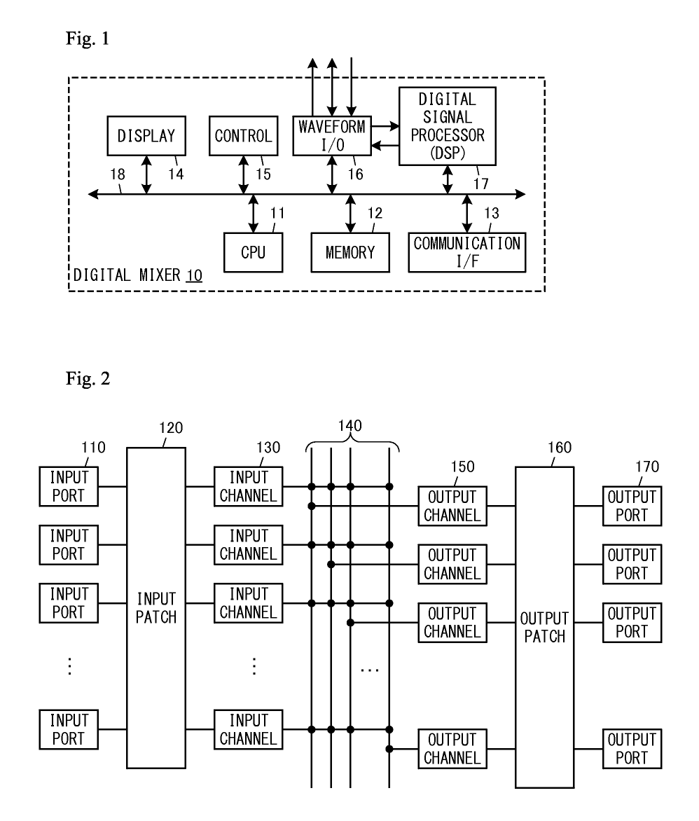

First, FIG. 1 illustrates a hardware configuration of a digital mixer as an embodiment of an audio signal processing device of the invention.

As illustrated in FIG. 1, the digital mixer 10 includes a CPU 11, a memory 12, a communication I/F (interface) 13, a display 14, a control 15, a waveform I/O 16, and a DSP (signal processing part) 17, which are connected via a system bus 18.

Among them, the CPU 11 is a controller that controls the overall operation of the digital mixer 10, and achieves various control functions including a parameter setting function which will be described later, by executing a necessary control program stored in the memory 12.

The memory 12 is a storage having a rewritable non-volatile storage storing control programs to be executed by the CPU 11 as well as data to be saved after the power is off and a storage area to be used as a work memory for the CPU 11.

The communication I/F 13 is an interface for communicating with other devices. The communication may be performed either via a network or via a direct connection. Further, irrespective of whether it is wired or wireless, any communication path can be employed.

The display 14 is a display for displaying a screen indicating the values of parameters used by the digital mixer 10 as well as a setting status and an operating status of the digital mixer 10. This screen includes a GUI (Graphical User Interface) operable by the user, and the display thereof are controllable by the CPU 11.

The control 15 is for accepting an operation to the digital mixer 10, and can be constituted of various keys, buttons, rotary encoders, knobs, sliders, and so on. Note that the display 14 and the control 15 may be structured integrally by using a touch display or the like.

The waveform I/O 16 is an interface for inputting and outputting an audio signal from/to the outside of the digital mixer 10.

The DSP 17 is an audio signal processor that performs various types of processes including mixing and equalizing through a plurality of signal processing channels on audio signals inputted from the waveform I/O 16, and supplies results thereof to the waveform I/O 16 to output them to the outside.

One of characteristic points of the above-described digital mixer 10 is a function for setting values of parameters used for signal processing in a signal processing part included in the input port. This point will be described below.

First, FIG. 2 illustrates in more detail a functional structure of input and output of an audio signal in the waveform I/O 16 and signal processing executed in the DSP 17. Among the functions of parts illustrated in FIG. 2, parts other than a part corresponding to terminals may be achieved by using software or hardware or a combination thereof.

In the structure illustrated in FIG. 2, the functions of input port 110 and output port 170 correspond to the input/output function of an audio signal in the waveform I/O 16, and the functions of a part of the input port 110, an input patch 120, an input channel 130, mixing buses 140, an output channel 150 and an output patch 160 correspond to the signal processing function in the DSP 17.

Among them, the input port 110 has a function to input an audio signal from an external device connected to a predetermined input terminal (or input-output terminal) of the waveform I/O 16. The input port 110 also has, when the audio signal outputted from the external device is an analog signal, a function to subject the analog signal to analog-digital (AD) conversion to input it as digital waveform data. The digital mixer 10 has a plurality (for example, forty-eight) of input ports 110.

Note that when a plurality of audio signals can be inputted from one terminal, there may be cases where a plurality of input ports 110 correspond to one input terminal. Further, when both input and output of an audio signal can be performed via one terminal, there may be cases where both an input port 110 and an output port 170 correspond to one input-output terminal.

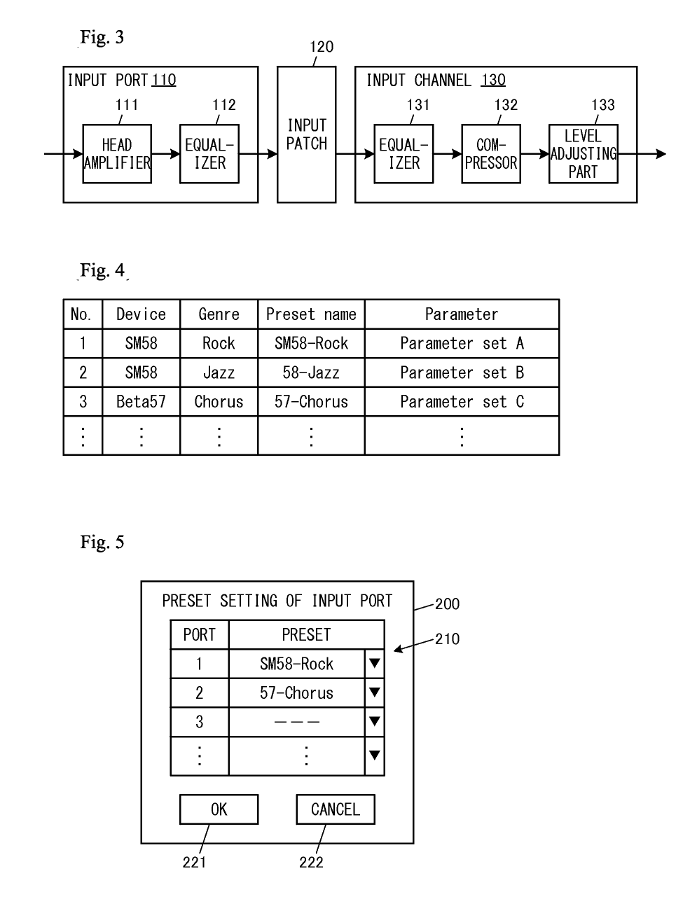

Further, as will be described later using FIG. 3, each input port 110 also has a signal processor achieved by the DSP 17 as a signal processor for processing an audio signal inputted from the input port 110.

The input patch 120 has a function to connect each of the input ports 110 and an arbitrary number, including zero, of input channels 130, and subject an audio signal inputted from each input port 110 to signal processing in each of the input channels 130 connected with the input port 110. It is not possible to connect a plurality of input ports 110 with one input channel 130.

The input channel 130 is a signal processing channel having a function to perform signal processing, such as equalizing or level adjustment, on an audio signal inputted from the input port 110 which is connected with the input channel 130 via the input patch 120, and output the audio signal after being processed to the mixing buses 140. On/off of output to each line of the mixing buses 140 can be switched arbitrarily in each line. The digital mixer 10 has a plurality of (for example, forty-eight) input channels 130.

The mixing buses 140 include a plurality of lines (for example, twenty-four lines) of buses, and each line has a function to mix audio signals inputted from the input channels 130 and subject the mixed signal to signal processing in the corresponding output channel 150.

The output channel 150 has a function to perform signal processing such as equalizing or level adjustment on audio signals supplied from the corresponding line in the mixing buses 140, and outputs the result. The digital mixer 10 has the same number of output channels 150 as the number of lines of the mixing buses 140.

The output patch 160 has a function to connect each of the output channels 150 and an arbitrary number, including zero, of output ports 170, and supply an audio signal as a processing result in each output channel 150 to the output port 170 connected with the output channel to output the audio signal. It is not possible to connect a plurality of output channels 150 with one output port 170.

The output ports 170 have a function to output an audio signal to an external device connected to a predetermined output terminal (or input-output terminal) of the waveform I/O 16. At this time, it may be configured so that digital waveform data can be subjected to digital-analog (DA) conversion to output it as an analog audio signal. The digital mixer 10 has a plurality (for example, forty-eight) of output ports 170.

The signal processing and connections in the above-described parts are executed according to the values of predetermined parameters stored in the memory 12 as ones to be reflected on the operation of the digital mixer 10.

Next, FIG. 3 illustrates a more detailed structure of the input port 110 and the input channel 130. FIG. 3 illustrates a structure of a signal processing function which each of the input ports 110 and the input channels 130 has.

As illustrated in FIG. 3, the input port 110 has a head amplifier 111 and an equalizer 112 as signal processing parts for processing an audio signal inputted to the input port 110.

Among them, the head amplifier 111 has a function to adjust the level of an audio signal according to set gain.

The equalizer 112 has a function to adjust frequency characteristics of the audio signal. This equalizer 112 can be configured as a graphic equalizer which allows the user to directly operate gain for a plurality of frequency bands or can be configured as a parametric equalizer which allows the user to set parameters of Q value, central frequency and gain to process the audio signal based on these parameters.

The input port 110 may have, besides them, a signal processing part for adjusting characteristics of an analog audio signal before AD conversion. In any case, it is assumed that the signal processing parts which the input port 110 has are used for correcting characteristics of an audio signal depending on characteristics of a device (such as a microphone or an audio signal reproducing device) which is connected to the input port 110 and supplies an input audio signal, so as to generate an input audio signal having common characteristics not depending on characteristics of the device. However, it may be used for other purposes. Further, although in practice the device is connected to the terminal corresponding to the input port 110, for simplicity of explanation it is assumed to be connected to the input port 110. The same applies below.

Further, the input channel 130 has an equalizer 131, a compressor 132 and a level adjusting part 133 as signal processing parts for processing an audio signal supplied from the input port 110 which is connected with the input channel 130 via the input patch 120. An output of the level adjusting part 133 is supplied to the mixing bus 140 of each line via an on-off control part of each line.

The equalizer 131 has a function to adjust frequency characteristics of the audio signal similarly to the equalizer 112. However, the number of adjustable parameters and the configuration thereof need not be the same as those of the equalizer 112.

The compressor 132 has a level adjusting function adjusting the dynamic range of an audio signal by performing level adjustment dynamically according to the level of an inputted audio signal. The relation between the level and gain of an input audio signal can be set as a parameter.

The level adjusting part 133 has a level adjusting function to perform level adjustment of the audio signal according to the set gain.

It is assumed that these signal processing parts which the input channel 130 has are used for adding, to an audio signal adjusted in characteristics at the input port 110 and having common characteristics not depending on the device which supplies the input audio signal, characteristics corresponding to the use of the audio signal. However, they may be used for other purposes. Note that the use is, for example, the genre of music, the type of a musical instrument (including vocal), or the like.

The signal processing function of the above-described parts is achieved by the DSP 17 reading predetermined parameter values stored in the memory 12 as ones to be reflected on the operation of the digital mixer 10 and operating according to the values.

The values of the parameters are basically set by the CPU 11 according to an operation by the user.

However, in the digital mixer 10, besides that, a set of values of parameters to be used by the signal processing parts of one input port 110 is prepared in advance as a preset correlated with the device connected to the input port 110, to thereby enable a batch setting using the preset.

FIG. 4 illustrates examples of the preset stored in the digital mixer 10.

Illustrated in FIG. 4 is a preset table storing information of presets, and this table is stored in the memory 12.

In the table, “No.” indicates a preset number as identification information for identifying a preset.

“Device” indicates the model of the device connected to the input port 110.

“Genre” indicates the genre of music related to the audio signal inputted from the input port 110. It is conceivable that a signal inputted from the same device may differ in “common characteristics” as targets depending on the genre, and thus the preset is prepared also in correlation with the genre. However, setting of the item “Genre” is not essential.

“Preset name” is the name of a preset and allows the user to identify the preset.

“Parameter” is a set of values of parameters used by the signal processing parts of the input port 110.

In the above preset table, data of one row are data of one preset.

The digital mixer 10 can obtain data of presets provided by the manufacturer of the digital mixer 10, the manufacturer of the device connected to the input port 110, or the like by reading from a storage medium or downloading via a network, and register the data in the preset table.

Further, a set of the values of parameters which are set to be reflected on the operation of one input port at a certain time point can be registered as a preset according to an instruction by the user. In this case, the “preset name” is specified arbitrarily by the user. The “Device” and the “Use” may be set automatically if they can be obtained automatically from the uses of the connected device or the digital mixer 10, or the like set in the digital mixer 10 at the time of the registration. If they cannot be obtained automatically, values of these items are specified by the user.

Next, in the digital mixer 10, setting of parameters of the input ports 110 by using the presets can be performed by the user directly specifying a preset.

FIG. 5 illustrates an example of a preset setting screen for performing this specification.

The preset setting screen 200 illustrated in FIG. 5 is a GUI displayed on the display 14 by the CPU 11 according to an instruction by the user, and has a preset specifying section 210, an OK button 221 and a cancel button 222.

Among them, the preset specifying section 210 is a section for accepting, for each input port 110, a specification of a preset used for setting parameters of the signal processing parts of the input port 110. The preset specifying section 210 has a pull-down menu for choosing a preset for each input port, and the user can specify one of the presets registered in the preset table illustrated in FIG. 4 as a preset used for setting parameters in the relevant input port. At this time, options of the presets are displayed by preset names registered in the preset table.

The specification of a preset in the preset specifying section 210 can be comprehended as a setting to connect the device corresponding to the specified preset to the input port 110.

Further, this preset specifying section 210 can be scrolled as appropriate. Further, as illustrated for the third input port, a specification not to use any preset is also possible. It is preferable that initial value of the pull-down menu with respect to each input port is a specification not to use any preset.

The OK button 221 is a button for fixing the specification in the preset specifying section 210 and closing the preset setting screen 200, and the cancel button 222 is a button for discarding the specification in the preset specifying section 210 and closing the present setting screen 200.

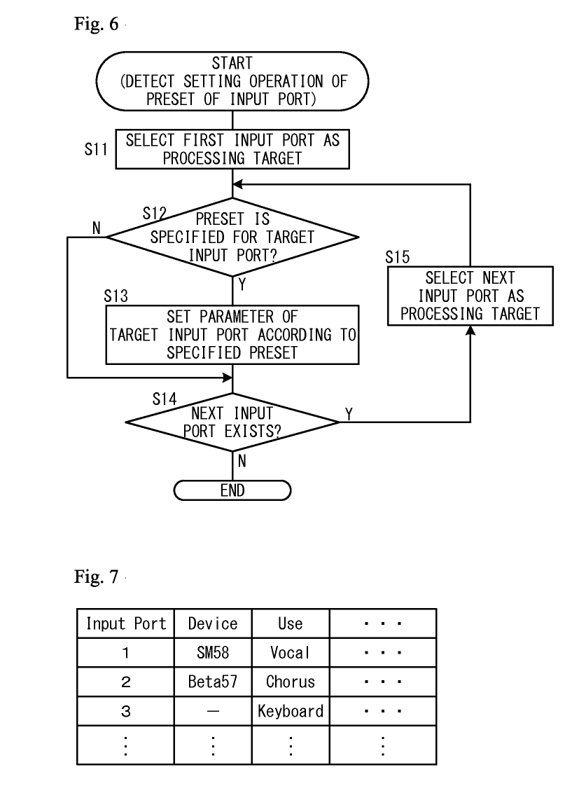

Next, FIG. 6 illustrates a flowchart of a process executed by the CPU 11 when the OK button 221 is pressed on the preset setting screen 200.

Upon detecting that the OK button 221 is pressed on the preset setting screen 200, the CPU 11 starts the process illustrated in FIG. 6, and repeats processes of steps S12 and S13 with all the input ports 110 being a processing target in order from the first (S11, S14, S15). Specifically, when any one of the presets is specified in the preset specifying section 210 for the target input port 110 (Yes in S12), the values of parameters of the signal processing parts provided in the target input port 110 are set according to the set of the parameters included in the specified preset (S13). When none of the presets is specified (No in S12), the values of the parameters of the target input port 110 are not changed.

By the above process, the user can set the values of parameters of the signal processing parts included in the input port 110 by using a preset registered in advance. At this time, by specifying the preset corresponding to the device connected to the input port 110 with reference to the preset name, the audio signal as a processing result in the input port 110 can be one which does not depend on the characteristics of the connected device. Thus, even when the device connected to the input port 110 is changed, just changing the specification of the preset corresponding thereto enables to obtain a processing result similar to that before the device is changed without changing the values of parameters of the signal processing in the input channels 130.

Note that the values of parameters set in the process of FIG. 6 can thereafter be edited individually according to a separate instruction from the user.

The digital mixer 10 also has, besides the above ones, a function to automatically apply a preset when the device connected to the input port 110 is specified. This specification can be performed based on a circuit table for example.

The circuit table is information specifying, for each input port 110, the model of the device connected to the input port 110 and the use thereof, or the like. These pieces of information are used by the user to generally comprehend information of the device connected to the digital mixer 10, and can be created as electronic data. The digital mixer 10 can read and store the data, and use to display the device name or the like. Further, after the digital mixer 10 reads the data in, the user can edit the data.

FIG. 7 illustrates a data example of the circuit table.

The circuit table illustrated in FIG. 7 includes various types of information such as “Input port”, “Device”, and “Use”.

Among them, the “Input port” indicates the identification number of the input port 110.

The “Device” indicates the model of the device connected to the relevant input port 110. This model is desired to be described using the information of the “Device” in the preset table.

The “Use” indicates the use of an audio signal inputted from the relevant input port 110. This use may be described using or not using the “Genre” in the preset table.

Note that data in the circuit table need not include information related to all the input ports 110, where any of the items may be blank (no information).

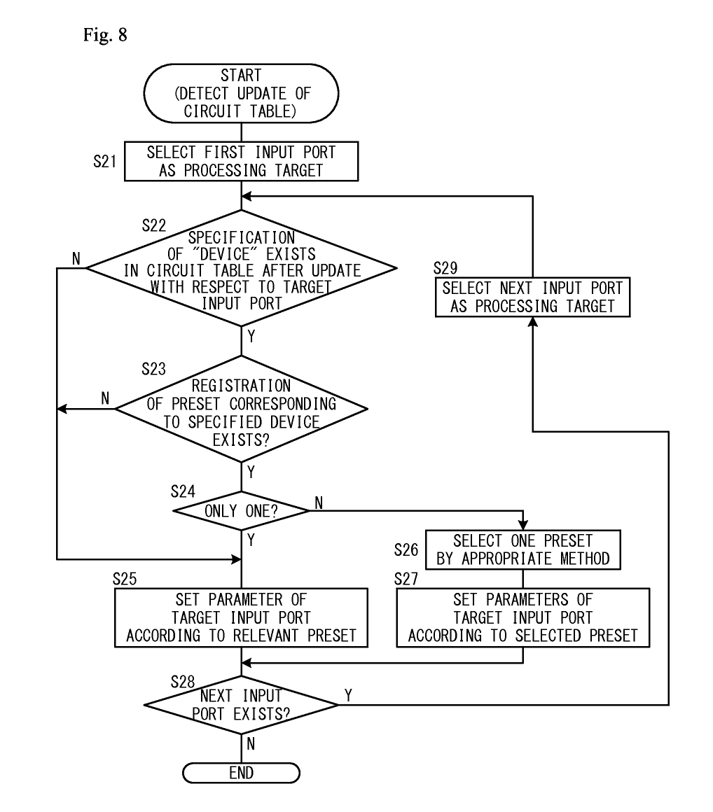

Next, FIG. 8 illustrates a flowchart of a process executed by the CPU 11 when data of the circuit table are updated. Note that only a process related to the setting of parameters by using a preset is described as this process, and it would not cause a problem if a process for utilization of updated data is performed besides this simultaneously or sequentially.

Upon detecting that the data of the stored circuit table are updated, the CPU 11 starts the process illustrated in FIG. 8. This update is performed when, for example, data of a new circuit table are read in or data of the circuit table which are already stored are edited according to an instruction by the user or automatically. Further, when these reading and editing are performed, the CPU 11 functions as an accepting device for accepting input of data of the circuit table.

In the process of FIG. 8, the CPU 11 repeats the process from step S22 to step S27 with all the input ports 110 being a processing target in order from the first (S21, S28, S29).

That is, when there is a specification of “Device” in the circuit table after being updated for the target input port (Yes in S22), the CPU 11 judges whether a preset corresponding to the device is registered in the preset table (S23).

Then, when there is a registration (Yes in S23) and it is only one (Yes in S24), the CPU 11 sets the values of parameters of the signal processing parts provided in the target input port 110 according to a set of values of the parameters included in the preset (S25).

When there is a plurality of registrations (No in S24), the CPU 11 selects one preset from the found presets by an appropriate method (S26), and sets the values of the parameters similarly according to the selected preset (S27). For example, the case where there is a preset table of FIG. 4 and a device “SM58” is set, or the like. Any method may be employed as the method of the selection, such as offering candidates to the user and allowing selection, selecting in consideration of the “Use”, or selecting one with a smaller number by priority.

Further, when there is no registration in step S23, setting of the values of parameters is not performed for the target input port 110.

By the above process, the digital mixer 10 can function as an identifying device for identifying the device connected to the input port 110 based on data of the circuit table, and can function as a parameter setting device for automatically setting the values of the parameters of the signal processing parts provided in the input port 110 to the values corresponding to the device connected to the input port 110. Thus, without updating the values of the parameters of the signal processing in the input channel 130 according to the model of the device connected to the input port 110, the user can obtain a similar processing result irrespective of the model.

Incidentally, when the user manually updates the specification of the device connected to the input port 110, a process similar to steps S23 to S27 of FIG. 8 may be performed. In this case, the input port 110 related to the update of the specification is the target input port. Further, the CPU 11 identifies the device connected to the input port 110 based on the specification by the user.

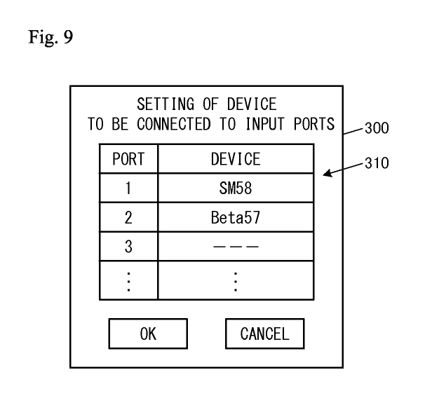

The specification of the device in this case can be performed by inputting the model name of the device connected to each input port 110 in a device specifying section 310 in a device specifying screen 300 as illustrated in FIG. 9 for example.

Besides them, when the digital mixer 10 is capable of automatically detecting the model of the device connected to the input port 110, the values of the parameters of the signal processing parts provided in the input port 110 may be set automatically by using a preset corresponding to the detected model, similarly to the process of steps S23 to S27 of FIG. 8, in response to a detection of the model. In this case, the CPU 11 identifies the device connected to the input port 110 based on a result of the automatic detection.

This concludes the explanation of the embodiment, but the structure of the device, the specific structure of the screen, the structure of the signal processing parts, the structure of data, the specific procedures of processes, the operating methods, and the types of parameters settable by using a preset, and so on are not limited of course to those explained in the above-described embodiment.

For example, with respect to the equalizer 112 of the input port 110 and the equalizer 131 of the input channel 130, it is not essential to perform the process of frequency characteristic adjustment individually. For example, a frequency characteristic adjustment process related to an adjustment amount obtained by combining the adjustment amount determined from parameters of the equalizer 112 of a certain input port 110 and the adjustment amount determined from parameters of the equalizer 131 of the input channel 130 which is connected with the certain input port 110 may be performed in the equalizer 131 of the input channel 130. When it is difficult to perform the process related to the combined adjustment amount as it is in relation with the number of bands or the like, an approximation may be performed appropriately.

Also in this manner, if the parameters can be set individually on the input port 110 side and the input channel 130 side, finally obtained processing results are substantially the same as in the case where the process is performed individually in the equalizer 112 and the equalizer 131. Further, the effect to reduce a setting work load can be obtained similarly. On the other hand, the processing load of the frequency characteristic adjustment process can be reduced as compared to the case where the process is performed individually. Thus, such a configuration is useful in the case where the processing performance of the DSP 17 is low.

Further, the signal processing parts provided in the input port 110 or the input channel 130 are not limited to those illustrated in FIG. 4.

Moreover, the parameters to be set by using the preset may be only a part of the signal processing parts provided in the input port 110, for example, parameters of the equalizer 112 only. Parameters related to adjustment with respect to characteristics not depending on the type of the connected device and adjustment with respect to characteristics which are desirable to be set based on ones other than the type of the device are rather desired not to be the target of the setting using the preset in the sense of the above-described embodiment.

Further, in the above-described embodiment, the preset is prepared in correlation with the model of the device connected to the input port 110. However, when a characteristic difference in each individual device cannot be ignored, presets may be prepared in correlation with individual devices. In this case, identification of the device connected to the input port 110 is performed in an individual unit, and the preset corresponding to the identified individual unit is used to set parameters.

Further, the present invention can be applied to an audio signal processing device other than the digital mixer, such as a multi-track recorder or a synthesizer with a sampling function.

Further, the functions related to setting of parameters by using the preset which have been described above can be provided in a device other than the device (the digital mixer 10 in the above-described embodiment) which operates using the values of the parameters. For example, it can be provided in a remote controller of the digital mixer 10 or the like. In this case, the remote controller may have dedicated hardware, or may be a general-purpose computer, such as a smart phone, a tablet computer, or a PC (personal computer). Further, the functions related to setting of parameters by using the preset may be achieved by cooperation of a plurality of devices.

Further, it is possible that the configurations and modifications thereof which have been described above can be applied in an appropriate combination within a range in which they do not contradict.

### INDUSTRIAL APPLICABILITY

As is clear from the above explanation, according to the present invention, the troublesome work of changing setting when a device connected to an input port is changed can be reduced in an audio signal processing device having signal processing channels processing an audio signal inputted from input ports.

Thus, by applying the present invention, operability of parameter setting can be improved.

### REFERENCE SIGNS LIST

10 . . . digital mixer, 11 . . . CPU, 12 . . . memory, 13 . . . communication I/F, 14 . . . display, 15 . . . control, 16 . . . waveform I/O, 17 . . . DSP, 18 . . . system bus, 110 . . . input port, 111 . . . head amplifier, 112 . . . equalizer, 120 . . . input patch, 130 . . . input channel, 131 . . . equalizer, 132 . . . compressor, 133 . . . level adjusting part, 140 . . . mixing bus, 150 . . . output channel, 160 . . . output patch, 170 . . . output port, 200 . . . preset setting screen, 210 . . . preset specifying section, 221 . . . OK button, 222 . . . cancel button

1. An audio signal processing device having an input port for inputting an audio signal from an outside and a signal processing channel for processing an audio signal inputted from the input port, the audio signal processing device comprising:
an identifying device configured to identify a device connected to the input port; and
a parameter setting device configured to set a value of a parameter, which is stored in a predetermined memory in correlation with the device identified by the identifying device, as a value of a parameter used in signal processing in a signal processing parts provided in the input port.

2. The audio signal processing device according to claim 1, further comprising an accepting device configured to accept input of a circuit table indicating a correlation between the input port and a device connected to the input port,
wherein the identifying device identifies the device to be connected to the input port based on the circuit table accepted by the accepting device, and
wherein the parameter setting device executes the setting automatically when the accepting device accepts input of the circuit table.
